(19) United States
(12) Patent Application Publication
(10) Pub. No.: US 2016/0108565 A1
(43) Pub. Date: Apr. 21, 2016

(54) COOLING TOWEL AND METHOD OF USING THE SAME

(71) Applicant: OccuNomix International LLC, Port Jefferson Station, NY (US)

(72) Inventor: Jennifer McCoy, Lake Grove, NY (US)

(21) Appl. No.: 14/516,698

(22) Filed: Oct. 17, 2014

(51) Int. Cl. D03D 27/08; B32B 7/08; A47K 10/02

(52) U.S. Cl. CPC D03D 27/08; A47K 10/02; B32B 7/08

(57) ABSTRACT

A cooling apparatus is disclosed, and comprises a body and a cloth section. The body is formed of a flexible and absorbent polymer material, and is configured to absorb fluid at a first rate. The cloth section is disposed in direct contact with the body, and is configured to absorb fluid at a second rate that is greater than the first rate.

### FIELD

The present invention is directed to an apparatus for facilitating the transfer of heat from a user and/or a surrounding environment to provide cooling to a user, and in embodiments, to a wearable apparatus for providing cooling, drying, and/or otherwise providing comfort for a user.

### BACKGROUND

Cooling apparatuses are configured to provide cooling by facilitating heat transfer from a target object and/or surrounding environment, such as a user's body, articles of clothing worn by the user, and/or surrounding air. Cooling apparatuses may be used to provide relief to users operating in heated and/or humid environments, for example, construction workers, soldiers, police, firefighters, or any other individuals who may need to operate in hot and/or humid environments and/or who may become overheated in the course of their work.

During the course of such activities in which cooling apparatuses are used, users may perspire, i.e., sweat, as his or her body attempts to release heat to the surrounding environment. Thus, in many situations, the occurrence of overheating and perspiration are concomitant.

### SUMMARY

It is an object of the present invention to provide an apparatus for cooling relief to a user by facilitating heat transfer from the body of the user while additionally providing one or more surfaces for comfortable and absorbent engagement with perspiration on body portions of the user.

In an exemplary embodiment, a cooling apparatus comprises a body and a cloth section. The body is formed of a flexible and absorbent polymer material, and is configured to absorb fluid at a first rate. The cloth section is disposed in direct contact with the body, and is configured to absorb fluid at a second rate that is greater than the first rate.

In exemplary embodiments, the absorbent polymer material is a hydrogel.

In exemplary embodiments, the absorbent polymer material is at least partially water-soluble.

In exemplary embodiments, the absorbent polymer material is polyvinyl alcohol.

In exemplary embodiments, the absorbent polymer material comprises a blend of absorbent fibers.

In exemplary embodiments, the blend of absorbent fibers includes polyvinyl alcohol and at least one other absorbent fiber.

In exemplary embodiments, the at least one other absorbent fiber is selected from the group consisting of: acetate, polyester, nylon, polypropylene, and polyethylene.

In exemplary embodiments, the body of the cooling apparatus is formed of a plurality of polymer chains that are configured to cross-link in the presence of fluid.

In exemplary embodiments, the body of the cooling apparatus is configured to absorb a quantity of fluid greater than ten times than a weight of the body of the cooling apparatus.

In exemplary embodiments, the cloth section includes cotton.

In exemplary embodiments, the cloth section includes a woven base upon which one or more cotton fibers are looped.

In exemplary embodiments, the cloth section is formed of terry cloth.

In exemplary embodiments, the body of the cooling apparatus has a planar configuration.

In exemplary embodiments, the body of the cooling apparatus has a rectangular configuration.

In exemplary embodiments, the body of the cooling apparatus defines a pair of opposed end sections, the cloth section is disposed in direct contact with one of the opposed end sections and another cloth section in direct contact with the other of the opposed end sections.

In exemplary embodiments, the cloth section is stitched to the body.

In exemplary embodiments, the body of the cooling apparatus has a length between 27 and 29 inches.

### BRIEF DESCRIPTION OF THE DRAWINGS

The features and advantages of the present invention will be more fully understood with reference to the following detailed description of illustrative embodiments of the present invention when taken in conjunction with the accompanying figures, wherein:

FIG. 1 is a top perspective view of a cooling apparatus according to an exemplary embodiment of the present disclosure;

FIG. 2 is a bottom perspective view of the cooling apparatus of FIG. 1;

FIG. 3A is a first sequential view of the cooling apparatus of FIG. 1 being exposed to fluid;

FIG. 3B is a second sequential view of the cooling apparatus of FIG. 1 being exposed to fluid, shown along section line 3-3;

FIG. 3C is a third sequential view of the cooling apparatus of FIG. 1 being exposed to fluid, shown along section line 3-3;

FIG. 4 is a perspective view of the cooling apparatus of FIG. 1 being worn around a body portion of a user;

FIG. 5A is a first sequential view of the cooling apparatus of FIG. 1 with a quantity of fluid being absorbed from one portion of the cooling apparatus by another portion of the cooling apparatus; and

FIG. 5B is a second sequential view of the cooling apparatus of FIG. 1 with a quantity of fluid being absorbed from one portion of the cooling apparatus by another portion of the cooling apparatus.

### DETAILED DESCRIPTION OF EMBODIMENTS

The headings used herein are for organizational purposes only and are not meant to be used to limit the scope of the description or the claims. As used throughout this application, the words “may” and “can” are used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

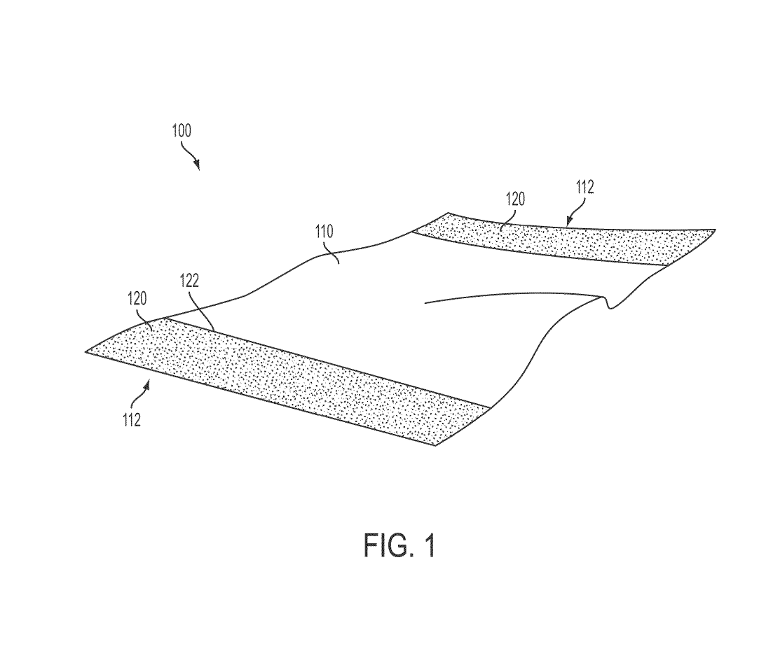

Turning to FIG. 1, a top perspective view of a cooling apparatus is generally designated as 100. Cooling apparatus 100 is formed of a body 110 and defines a pair of end sections 112 along terminal portions of the body 110. A pair of cloth sections 120 are disposed the end sections 112 along an upper surface of the body 110, as shown. While the body 110 of cooling apparatus 100 is illustrated as having a generally rectangular, planar configuration, body 110 may in embodiments have any of a number of desired shapes and/or configurations, for example, circular, ovular, or square, to name a few, with end sections defined along different respective portions thereof.

Body 110 of cooling apparatus 100 has a generally flexible configuration so that the body 110 can be, for example, folded, curved, and/or twisted depending on a desired use. Further, body 110 is formed of a material that is configured to readily absorb fluids upon contact, e.g., body 110 is formed of a material that includes a series of pores within which fluids such as water or sweat readily migrate and/or the material is configured to bond with fluids upon contact. Accordingly, body 110 may be formed of one or more flexible and absorbent materials, for example, polymeric material such as polyvinyl alcohol (PVA). In embodiments, body 110 may be formed of a material that is at least partially water-soluble. In embodiments, body 110 may be formed of a blend of materials, for example, a plurality of PVA fibers with a matrix of other absorbent fibers, for example, acetate, polyester, nylon, polypropylene, and/or polyethylene, to name a few.

With continued reference to FIG. 1, cloth sections 120 are overlaid and in direct contact with end sections 112 of the body 110. Cloth sections 120 may have a softened and/or luxurious feel, and are configured for comfortable engagement with a lightly covered or exposed portions of a user's body, such as a user's skin. Cloth sections 120 may have a more textured surface than the body 110 of cooling apparatus 100, for example, which may have a smooth and or minimally-featured outer surface. Accordingly, cloth sections 120 may include bristles or fibers that extend therefrom and that move upon frictional and/or interfering engagement with another object such as a portion of a body of a user. In embodiments, cloth sections 120 may be formed of a cotton material such as terry cloth, in which numerous cotton fibers are repeatedly looped along an interwoven base structure to provide both high fluid absorption capability as well as a luxurious sensation upon contact with a user's skin.

Cloth sections 120 may be attached to an outer surface of the body 110 of cooling apparatus 100 by fastening through stitching such that a seam 122 extends along an outer periphery of the cloth sections 120, as shown. In embodiments, cloth sections 120 may be attached to an outer surface of the body 110 through other types of joining, for example, adhesives, buttons or snaps, to name a few. In embodiments, cloth sections 120 may be removable from the body 110 of cooling apparatus 100.

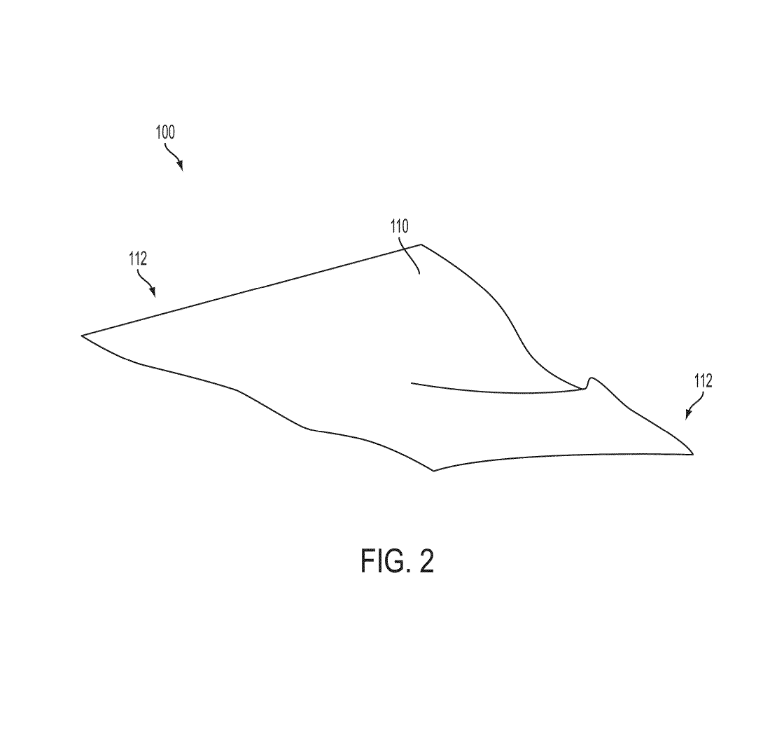

With additional reference to FIG. 2, an underside portion of body 110 may be devoid of cloth sections 120 such that an orientation of the cooling apparatus 100 can easily be determined, e.g., by quickly identifying an upper-facing side and a lower-facing side. In this regard, cooling apparatus 100 may suggest a body-facing side and an outward-facing surface by the location of cloth sections 120. While body 110 has been illustrated having a pair of cloth sections 120 formed along opposing end sections 112 of a planar side of body 110, it will be understood that, in embodiments, cooling apparatus 100 may have any desirable number and/or arrangement of cloth sections 120 on one or multiple exposed surfaces.

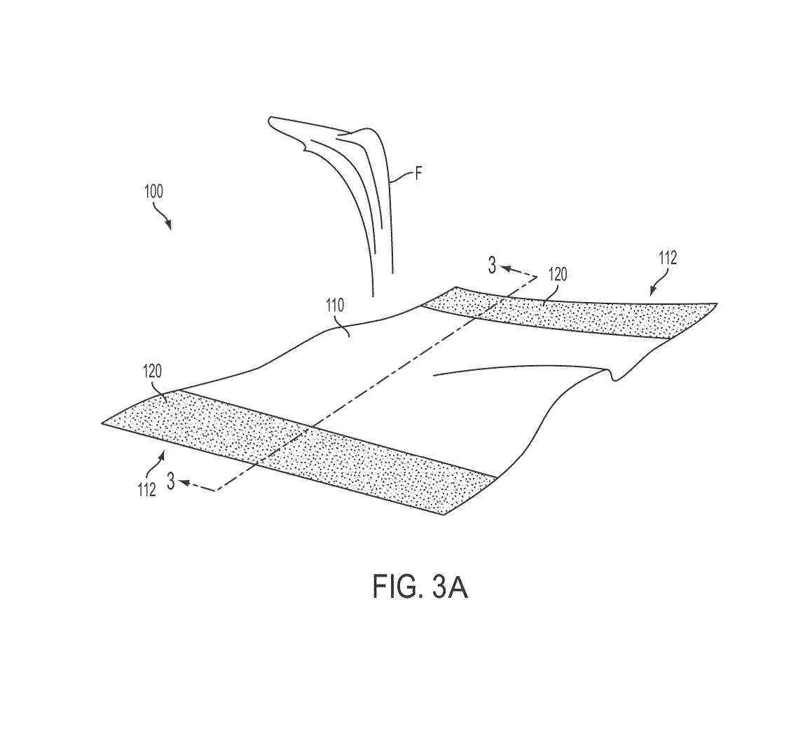

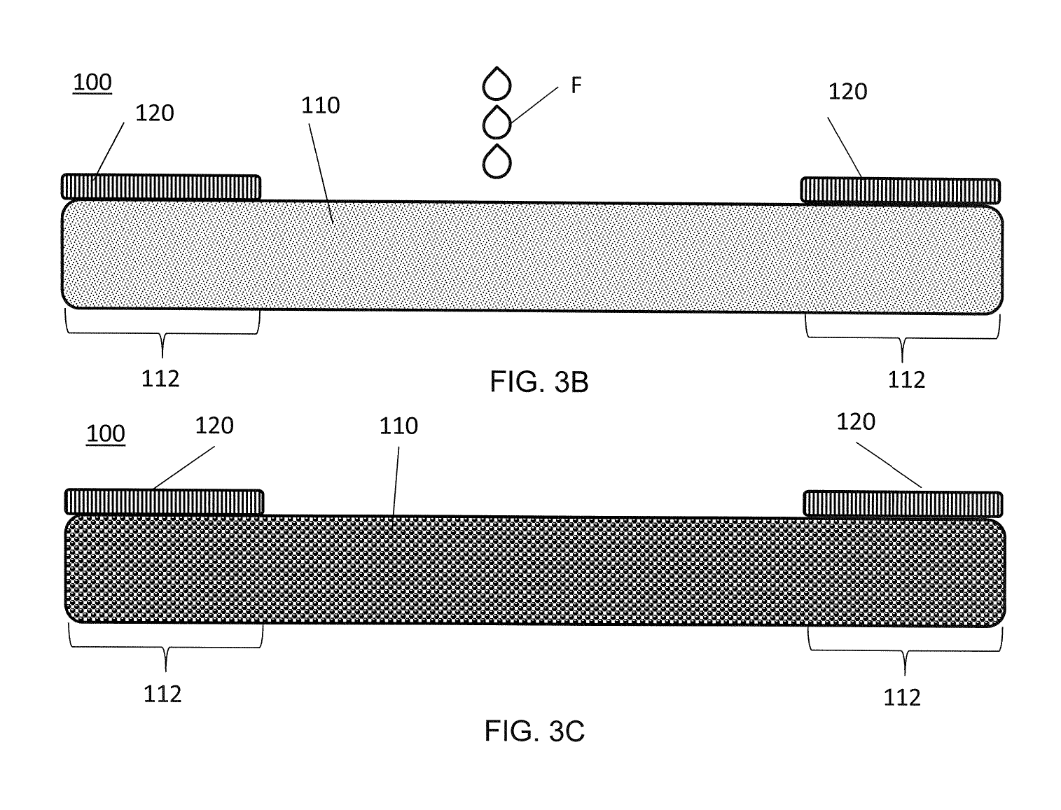

Turning now to FIGS. 3A, 3B, and 3C, use and operation of cooling apparatus 100 will be described in detail.

FIG. 3A illustrates a quantity of fluid F being brought into contact with cooling apparatus 100. While fluid F is shown being a liquid poured onto cooling apparatus 100, it will be understood that fluid F may include liquids and/or gases, and that a variety of methods of bringing fluid F into contact with apparatus 100 may be used, for example, steaming or other vapor deposition, dipping, soaking, and/or spraying, to name a few.

Referring to FIGS. 3B and 3C, a cross-section of the body 110 of cooling apparatus 100 is shown along line 3-3 (FIG. 3A). As fluid F is brought into contact with the body 110 of cooling apparatus 100, body 110 contacts and draws fluid F into the interior of body 110, for example, through hydrogen bonding of portions of the body 110 with fluid F. In embodiments, body 110 may define a plurality of pores therein configured to accommodate quantities of fluid F. The body 110 of cooling apparatus 100 may develop a gel-like feel due to cross-linking of constituent polymer chains in the presence of fluid F.

In this regard, the body 110 of cooling apparatus 100 may be configured to absorb a quantity of fluid F in excess of the weight of body 110. In embodiments, body 110 of cooling apparatus may be configured to absorb a quantity of fluid F in excess of ten times the weight of body 110, for example, 11 times the weight of body 110, 12 times the weight of body 110, or 13 times the weight of body 110, to name a few.

As the fluid retention capacity of body 110 may be greater than desired by a user, e.g., body 110 may absorb and retain fluid F of a quantity sufficient to saturate body 110 with fluid F such that body 110 becomes excessively weighted and/or wet to the touch, a user may optionally eject fluid F from the cooling apparatus by exerting a compressive force on one or more portions of body 110, e.g., by wringing or squeezing the cooling apparatus 100. In embodiments, a user may desire to reduce the volume of fluid retained by body 110 such that additional fluid retention capacity is available to absorb further quantities of fluid.

It will be understood that fluid F may be selectively applied solely to the body 110 of cooling apparatus 100, or may be applied to both the cloth sections 120 and the body 110 of cooling apparatus 100, as described further herein.

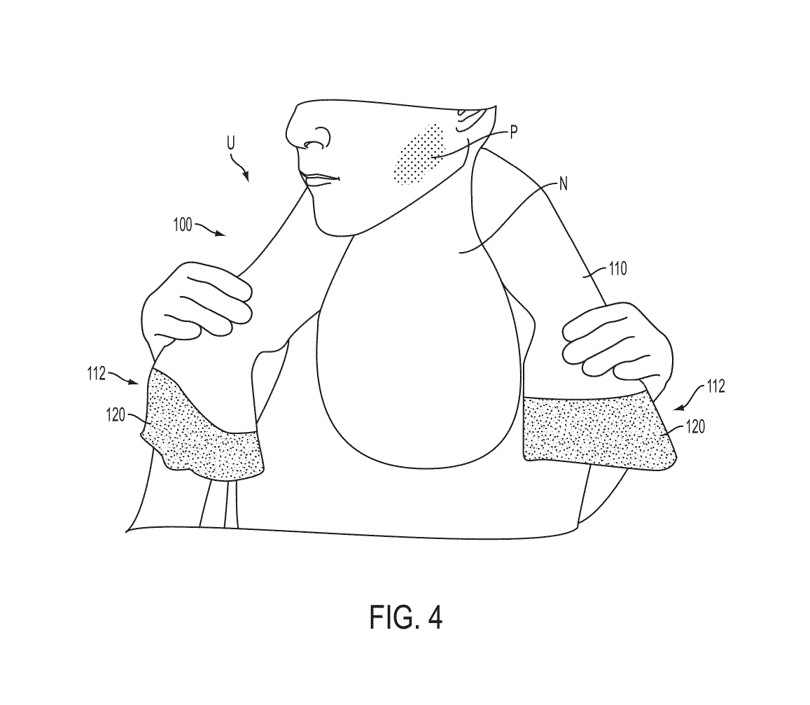

Turning to FIG. 4, a user U is shown with cooling apparatus 100 disposed around a portion of his or her body. In the exemplary embodiment shown, user U has folded and draped the cooling apparatus 100 about his or her neck N such that the end sections 112 of the body 110 are positioned to rest upon the user's shoulders, clavicles, and/or chest, as shown.

Cooling apparatus 100, as shown, has a length sufficient that user U may move, e.g., reposition, end sections 112 of the body 110 containing cloth sections 120 without substantially altering the positioning of the main portion of the body 110 disposed about his or her neck N. In embodiments, body 110 may have a length greater than 24 inches, for example, 25 inches, 26 inches, 27 inches, 28 inches, 29 inches, or 30 inches, to name a few. In this regard, the user U is afforded a degree of freedom to move and/or manipulate the sections of body 110 containing cloth sections 120 without disengaging the cooling apparatus 100 from his or her neck N. Accordingly, the cloth sections 120 may be used for one or more additional purposes while the substantial remainder of the cooling apparatus 100 remains in contact with and cools the body of the user U.

Accordingly, user U may engage either or both of the cloth sections 120 with another portion of his or her body, for example, a portion of his or her head. Because cloth sections 120 may have a softened and/or luxurious feel, cloth sections 120 may be used to wipe, dab, and/or blot portions of the body of user U that are covered in fluids F (FIG. 3A). In embodiments, cloth sections 120 may be used to contact portions of the body of user U that are covered with fluids generated by the user's body, such as perspiration P, as shown.

Cloth sections 120, like body 110 of cooling apparatus 100, are configured to absorb fluid F, which may include perspiration P, for example, by drawing in and retaining fluid F within pores formed along fibers extending from the cloth sections 120 and/or through hydrogen bonds formed between portions of body 110 and fluid F. However, cloth sections 120 may have a lower fluid retention capacity, e.g., become saturated with fluid more readily and/or have a higher evaporation point, than the body 110 of cooling apparatus 100 such that the cloth sections 120 release fluids via evaporation more slowly than body 110. Accordingly, it would be desirable for cooling apparatus 100 to facilitate the quick and efficient removal of fluids F, such as perspiration P, from cloth sections 120, e.g., so that cloth sections 120 can be continually used and/or to avoid discomfort to a user due to deposition of fluid F retained in the cloth sections 120 on the body of user U.

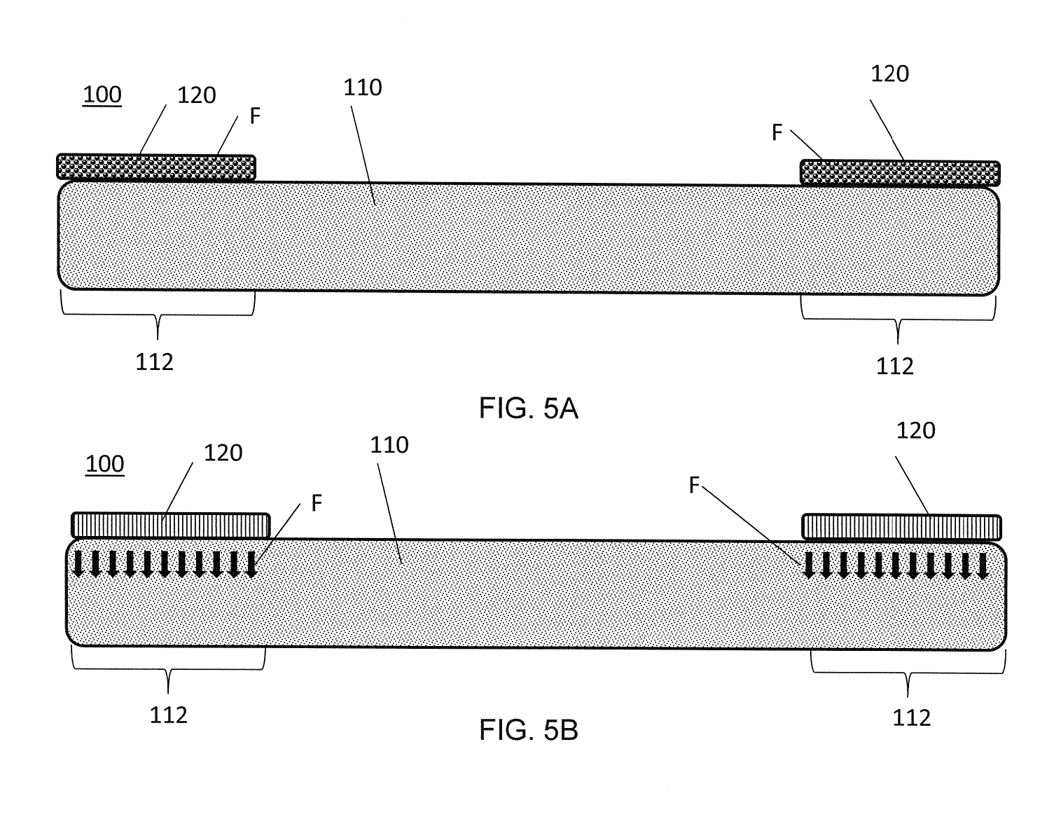

Turning to FIG. 5A, cooling apparatus 100 is again shown in cross-section along the line 3-3 (FIG. 3A). Cloth sections 120, as shown, have absorbed a quantity of fluid F as perspiration P (FIG. 4) from the body of a user U, or from other sources, such as fluids absorbed by body 110 of cooling apparatus 100 during preparation of the cooling apparatus 100 for use. While the body 110 of cooling apparatus 100 is shown substantially devoid of fluid F, it will be understood that body 110 of cooling apparatus 100 may retain a quantity of fluid F while absorbing additional fluids F from cloth sections 120 as described above.

With reference to FIG. 5B, the absorptive capabilities of the body 110 of cooling apparatus 100 may be greater than those of cloth sections 120 such that fluids F, which may include perspiration P and/or other fluids, are readily drawn from the cloth sections 120 into the body 110. In this regard, cloth sections 120 are configured to lose fluids F such as P or other fluids to a surrounding environment at a rate greater than that afforded by their independent capacity for evaporative drying due to their contact with the body 110 of cooling apparatus 100.

As such, the absorption of perspiration P or other fluids from the cloth sections 120 by the body 110 of cooling apparatus 100 affords the body 110 an additional and/or alternative source of fluids via which the body of user U can release heat through evaporative cooling. Further, due to the greater rate of absorption of fluid F of the body 110 of cooling apparatus 100 as compared to cloth sections 120, body 110 may continuously draw fluid F from cloth sections 120 such that cloth sections 120 are devoid of or minimally retain fluid F in quantities such that a user U may repeatedly contact cloth sections 120 with his or her body without a substantial loss in comfort and/or absorbency as compared to an original, unwetted condition of cloth sections 120.

While this invention has been described in conjunction with the embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. A cooling apparatus, comprising:
a body formed of a flexible and absorbent polymer material, the body configured to absorb fluid at a first rate; and
a cloth section disposed in direct contact with the body, the cloth section configured to absorb fluid at a second rate that is greater than the first rate.

2. The cooling apparatus of claim 1, wherein the absorbent polymer material is a hydrogel.

3. The cooling apparatus of claim 1, wherein the absorbent polymer material is at least partially water-soluble.

4. The cooling apparatus of claim 1, wherein the absorbent polymer material is polyvinyl alcohol.

5. The cooling apparatus of claim 1, wherein the absorbent polymer material comprises a blend of absorbent fibers.

6. The cooling apparatus of claim 5, wherein the blend of absorbent fibers includes polyvinyl alcohol and at least one other absorbent fiber.

7. The cooling apparatus of claim 6, wherein the at least one other absorbent fiber is selected from the group consisting of: acetate, polyester, nylon, polypropylene, and polyethylene.

8. The cooling apparatus of claim 1, wherein the body of the cooling apparatus is formed of a plurality of polymer chains that are configured to cross-link in the presence of fluid.

9. The cooling apparatus of claim 1, wherein the body of the cooling apparatus is configured to absorb a quantity of fluid greater than ten times than a weight of the body of the cooling apparatus.

10. The cooling apparatus of claim 1, wherein the cloth section includes cotton.

11. The cooling apparatus of claim 10, wherein the cloth section includes a woven base upon which one or more cotton fibers are looped.

12. The cooling apparatus of claim 1, wherein the cloth section is formed of terry cloth.

13. The cooling apparatus of claim 1, wherein the body of the cooling apparatus has a planar configuration.

14. The cooling apparatus of claim 1, wherein the body of the cooling apparatus has a rectangular configuration.

15. The cooling apparatus of claim 1, wherein the body of the cooling apparatus defines a pair of opposed end sections, the cloth section is disposed in direct contact with one of the opposed end sections and another cloth section in direct contact with the other of the opposed end sections.

16. The cooling apparatus of claim 1, wherein the cloth section is stitched to the body.

17. The cooling apparatus of claim 1, wherein the body of the cooling apparatus has a length between 27 and 29 inches.
